(19) United States
(12) Patent Application Publication
(10) Pub. No.: US 2005/0160611 A1
(43) Pub. Date: Jul. 28, 2005

(54) Wire gauging tool

(76) Inventor: Gerald Adam Nave, Johnson City, TN (US)

Correspondence Address: Gerald Adam Nave, 1810 West Lakeview Drive, Johnson City, TN, 37601, US

(21) Appl. No.: 11/005,351

(22) Filed: Dec. 6, 2004

Related U.S. Application Data
(60) Provisional application No. 60/538,361, filed on Jan. 22, 2004.

(51) Int. Cl. G01B 3/50

(52) U.S. Cl. 33/501.45

(57) ABSTRACT

A tool for measuring the outside insulation of electrical conductors (wire) in the electrical trade. The tool includes a set of leaves which are cut to match the various conductor insulations in the trade. The tools have leaves at each end or both ends. The tool is held together by means of a post and screw or other acceptable means that will allow the leaves to swing out to fit over the insulated conductors. The tool has engraved or printed text that has the amperage stated for copper and aluminum conductors a various ambient temperatures as well as the size measured in (kcmil) which is stated in circular mil area of the insulated conductor which will vary with the types of insulation used on the conductors.

### BACKGROUND

1. Technical Field

The present invention is directed to electrical wiring systems, and, in particular, to a wire gauging tool for determining a gauge size of an insulated wire and an allowable ampacity of the insulated wire.

2. Description of the Related Art

As current flows through a wire, voltage is converted to heat as a squared function of the current. The smaller the wire, the greater the resistance for any given length, all other factors being equal. A wire with greater resistance (R) will dissipate a greater amount of heat energy for any given amount of current (I), the power being equal to P=I²R.

Dissipated power in a resistance manifests itself in the form of heat, and excessive heat can be damaging to a wire and to objects near the wire, e.g., other wires, support beams, etc, especially considering the fact that most wires are insulated with a plastic or rubber coating, which can melt and burn. Thin wires will, therefore, tolerate less current than thick wires, all other factors being equal.

The current carrying capacity of a particular wire is dictated by its ampacity, i.e., how many amps it can handle. Ampacity is a function of the cross section area or diameter of the wire and its material type. Larger diameter wires have larger cross section areas and can safely carry more electrical current without overheating. The maximum ampacity for different types of wires is reported in the electrical codes used throughout the industry. These tables are based on the size of the wire and the particular insulation type for the particular wire.

When determining if a power distribution system is sized correctly, a user, e.g., an inspector or electrician, must readily determine the gauge size of the wire being used and then look up the allowable ampacity of the wire being employed. Conventional gauging devices require the user to shut down the distribution system, disconnect the wire under test and measure the gauge size of the wire on an uninsulated portion of the wire. Once the gauge size is determined, the user will determine the allowable ampacity from the gauge size and insulation type by conferring with a chart or electrical code book. This process is time consuming and requires the user to carry the conventional gauging tool, hand tools for disconnecting the wire and at least one reference book, e.g., the National Electric Code (NEC).

Therefore, it would be desirable to have a tool for easily determining a gauge size of an insulated wire without having to disconnect the insulated wire from a power distribution system. Furthermore, it would be advantageous for the tool to provide allowable ampacities of the determined wire gauge size to facilitate determining the proper wire size for a given circuit.

### SUMMARY

According to one aspect of the present invention, a wire gauging tool is provided. The wire gauging tool includes a plurality of wire gauging leaves for determining a wire gauge size of an insulated wire. Each wire gauging leaf includes at least one annular slot having a diameter corresponding to an insulated wire of the gauge size. Optionally, each wire gauging leaf includes an allowable ampacity for the corresponding wire gauge size at at least one operating at temperature. The allowable ampacity may be selected for copper or aluminum wire.

According to another aspect of the present invention, a wire gauging tool is provided including at least one wire gauging leaf for determining a wire gauge size and at least one ampacity leaf for determining the allowable capacity of the determined wire gauge size. The at least one wire gauging leaf includes a plurality of an annular slots, each slot having a diameter of an insulated wire corresponding to a wire gauge size. The ampacity leaf includes a plurality of allowable ampacities corresponding to the wire gauge size of the plurality of annular slots.

### BRIEF DESCRIPTION OF THE DRAWINGS

The above and other aspects, features, and advantages of the present invention will become more apparent in light of the following detailed description when taken in conjunction with the accompanying drawings in which:

FIG. 1 is a perspective view of a wire gauging tool according to a first embodiment of the present invention;

FIG. 2 is a perspective view of the wire gauging tool shown in FIG. 1 with a wire gauging leaf exposed;

FIG. 3 is a top plan view of a wire gauging leaf according to the first embodiment of the present invention;

FIG. 4 is a perspective view of a wire gauging tool according to a second embodiment of the present invention;

FIG. 5 is a perspective view of a wire gauging tool shown in FIG. 4 with several wire gauging leaves exposed;

FIG. 6 is a top plan view of a wire gauging leaf according to the second embodiment of the present invention; and

FIG. 7(a) is a top plan view of an ampacity chart for aluminum wire and FIG. 7(b) is a top plan view of an ampacity chart for copper wire.

### DETAILED DESCRIPTION

Embodiments of the present invention will be described herein below with reference to the accompanying drawings. In the following description, well-known functions or constructions are not described in detail to avoid obscuring the invention in unnecessary detail. In the figures, like reference numerals represent like elements.

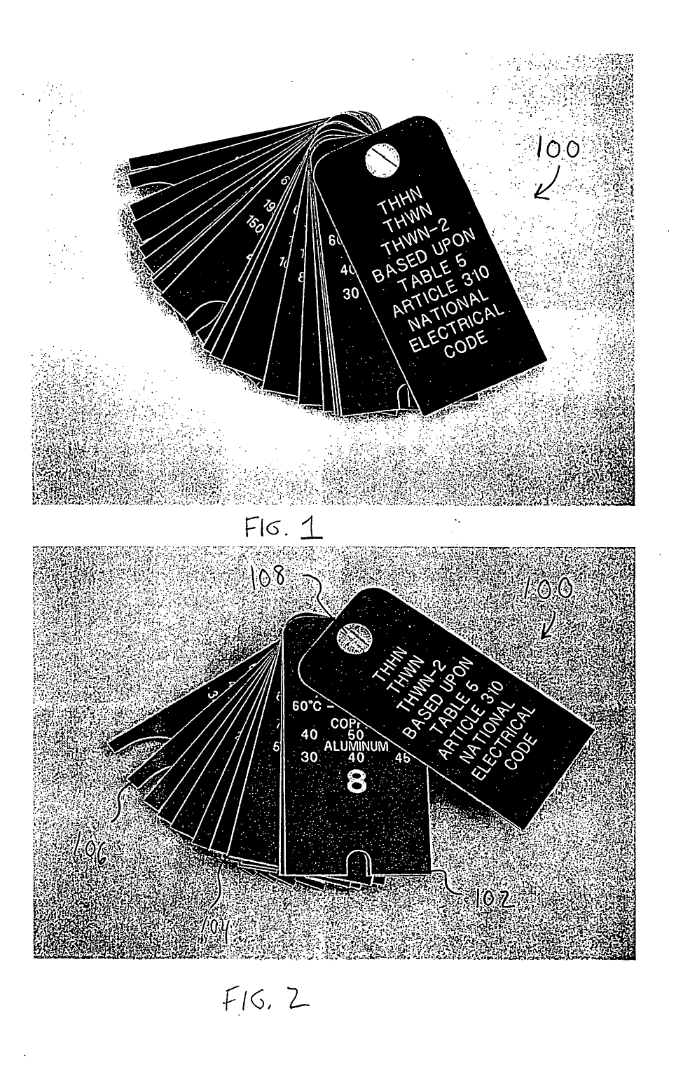

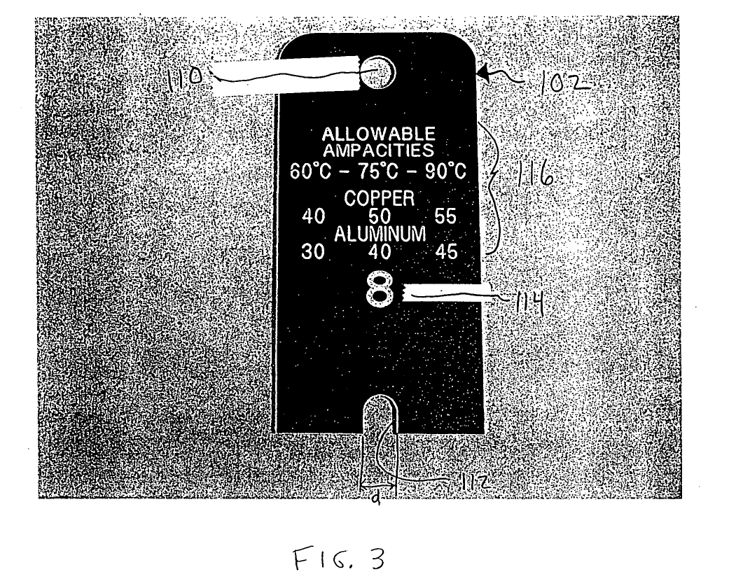

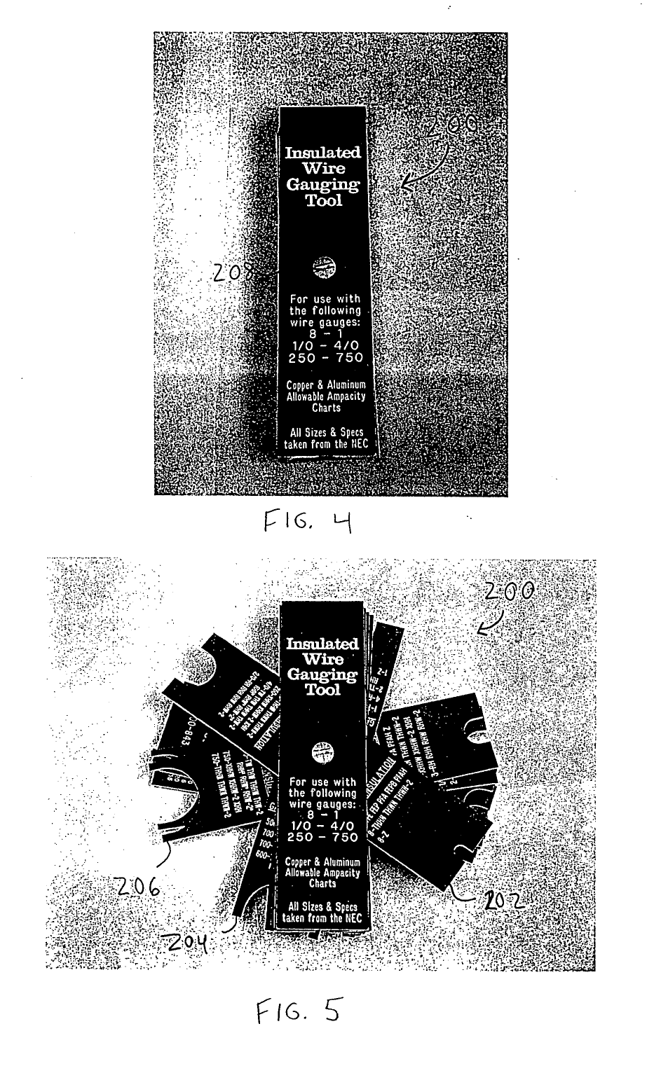

Referring to FIGS. 1 and 2, a wire gauging tool 100 according to a first embodiment of the present invention is provided. The wire gauging tool 100 includes a plurality of wire gauging leaves 102, 104 106 for determining a wire gauge size of an insulated wire. Each wire gauging leaf 102, 104 106 is manufactured from high impact laminated acrylic. As shown in FIG. 3, each of the plurality of leaves includes a hole 110 for accepting a post 108 for collectively holding the plurality of leaves. The post 108 allows a user to selectively expose a desired leaf while maintaining all of the plurality of leaves on the tool 100.

Referring to FIG. 3, an individual wire gauging leaf 102 is illustrated. The wire gauging leaf 102 includes slot 112 for determining a wire gauge size of an insulated wire. The slot 112 has a diameter d which corresponds to a wire gauge size having a predetermined type of insulator material surrounding the conductor of the wire. The diameter of the slots for each gauge size is taken from Table 5 of the National Electrical Code (NEC). In the embodiment shown, the insulator material is selected from the group consisting of THHN, THWN, or THWN-2.

In use, a user would find the appropriate leaf where the slot 112 snuggly mates over the insulated wire. Once the appropriate leaf is found, the user can readily determine the wire gauge size by viewing the number 114 engraved on the leaf, in this case, the wire gauge size is 8. Then, based on the type of conductor of the wire, e.g., copper or aluminum, the user can readily determine the allowable ampacity of the wire for a selected operating temperature from chart 116 which is engraved directly on the leaf 102. The allowable ampacities are taken from Table 310-16 of the National Electric Code (NEC).

Referring to FIGS. 4-7, a wire gauging tool 200 according to a second embodiment of the present invention is provided. The wire gauging tool 200 includes a plurality of wire gauging leaves 202, 204 206 for determining a wire gauge size of an insulated wire and at least one ampacity leaf 220, 222 for determining the allowable ampacity of the determined wire gauge size. Each wire gauging leaf 202, 204 206 and ampacity leaf 220, 220 is manufactured from high impact laminated acrylic. Each of the plurality of leaves includes a hole 210 for accepting a post 208 for collectively holding the plurality of leaves. The post 208 allows a user to selectively expose a desired leaf while maintaining all of the plurality of leaves on the tool 200.

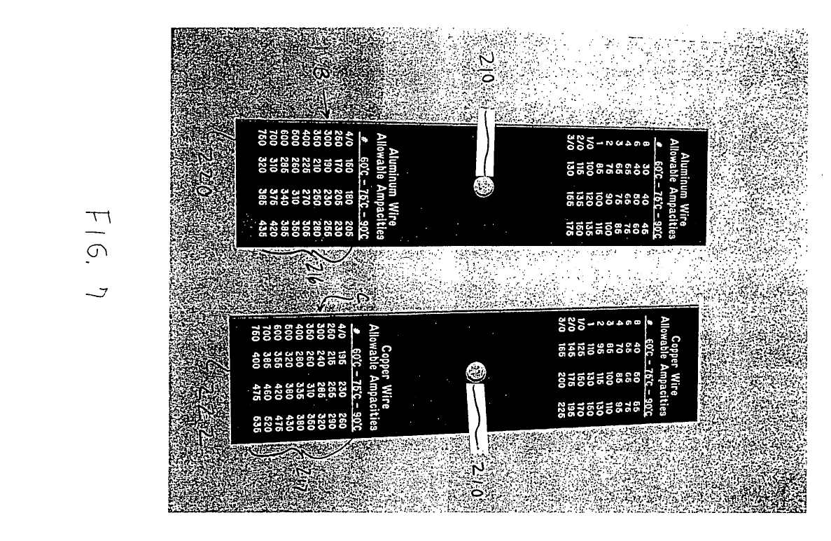

Referring to FIG. 6, an individual wire gauging leaf 202 is illustrated. The wire gauging leaf 202 includes a plurality of slots 212, 213 for determining a wire gauge size of an insulated wire. Each slot 212, 213 has a diameter d which corresponds to a wire gauge size having a predetermined type of insulator material surrounding the conductor of the wire. In use, a user would find the appropriate leaf where the slot 212 snuggly mates over the insulated wire. Once the appropriate leaf is found, the user can readily determine the wire gauge size by identifying the insulator material type from the gauge insulation chart 215 engraved on the leaf. For example, if the user has found leaf 202 is the appropriate leaf where slot 212 matches the insulated wire and has determined the insulation material to be THHW, the user can readily determine the wire gauge size as 300, as indicated by arrow A in FIG. 6.

Then, based on the type of conductor of the wire, the user can readily determine the allowable ampacity of the wire by selecting the appropriate ampacity leaf 220, 222. Continuing with the above example, if the conductor is aluminum, the user can ascertain the allowable ampacity from ampacity leaf 220 and viewing ampacity chart 216 for gauge size 300 as indicated by arrow B. Alternatively, if the conductor is copper, the user can ascertain the allowable ampacity from ampacity leaf 222 and viewing ampacity chart 217 for gauge size 300 as indicated by arrow C.

While several embodiments of the disclosure have been shown in the drawings, it is not intended that the disclosure be limited thereto, as it is intended that the disclosures be as broad in scope as the art will allow and that the specification be read likewise. Therefore, the above description should not be construed as limiting, but merely as exemplifications of preferred embodiments.

1. A tool for measuring electrical conductors comprising:
A set of gauges to match the different conductor sizes per the National Electrical Code (article 310-16) 2002 code
A slot cut in each leaf to match the conductor sizes per above code section and (table-5) NEC-2002 and the insulation types listed
A retainer post (post & screw or other means will pass through the leaves to allow them to swing out and slide over the outside insulation of the conductor.
A printed or engraved set of text for each leaf will match the ambient temperature and amperage allowed for the copper or aluminum conductor.

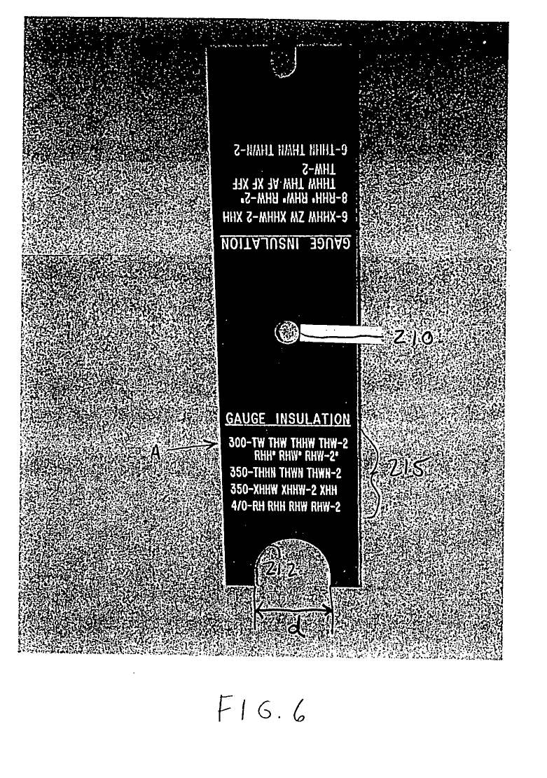

2. A tool of various leaves cut on one end as tool (100) (FIG. 1, 2) or on both ends as in tool (200) (FIGS. 4 and 5).

3. A tool of plastic or other non-conductive materials that the leaves swing out to fit over the insulation of the conductors which in turn will tell the operator the conductors size and the amperage rating for the ambient temperature used.
